(19) United States
(12) Patent Application Publication
(10) Pub. No.: US 2007/0059236 A1
(43) Pub. Date: Mar. 15, 2007

(54) Molecular sieves with high selectivity towards light olefins in methanol to olefin conversion

(76) Inventors: Robert W. Broach, Deerfield, IL (US); Mary A. Vanek, Schaumburg, IL (US); Andrzej Z. Ringwelski, Marengo, IL (US); Stephen T. Wilson, Libertyville, IL (US); Raelynn M. Miller, Lagrange, IL (US); John Q. Chen, Glenview, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/222,619

(22) Filed: Sep. 9, 2005

(51) Int. Cl. B01J 27/182; C01B 39/00

(52) U.S. Cl. 423/700; 502/214; 423/718

(57) ABSTRACT

A catalyst for the use in methanol to olefin conversion is identified, and a process for identifying the structure of the catalyst is presented, which is used to determine the quality of the catalyst for its selectivity for producing high light olefins yield.

### FIELD OF THE INVENTION

This invention relates to a catalyst which exhibits high selectivity for low molecular weight olefins in the conversion of oxygenates to olefins.

### BACKGROUND OF THE INVENTION

The traditional method of olefin production is the cracking of petroleum feedstocks to olefins. The cracking of petroleum feedstocks is done through catalytic cracking, steam cracking, or some combination of the two processes. The olefins produced are generally light olefins, such as ethylene and propylene. There is a large market for the light olefin products of ethylene and propylene. As petroleum feedstocks from crude oil face increasing prices it is advantageous to provide for other sources of ethylene and propylene. It is also known that olefins can be produced from oxygenates. The most common conversion of oxygenates to olefins is the production of light olefins from methanol, wherein methanol can be produced from other sources, including biomass, and natural gas.

The process of converting oxygenates to olefins is an important process for utilizing oxygenates, such as methanol, and converting them to higher value products such as monomers for plastics, such as ethylene and propylene. The process of converting oxygenates to olefins is a catalytic process, and the catalyst is usually a molecular sieve catalyst. Among the molecular sieves that are useful for the catalytic process are ZSM-type molecular sieves, but more particularly, it has been found that silico-aluminophosphate (SAPO) molecular sieves work well in the process.

SAPOs are synthesized by forming a mixture containing sources of silicon, aluminum, and phosphorus mixed with an organic template, and then crystallizing the molecular sieve at reaction conditions. Many factors affect the form the molecular sieve takes, including the relative amounts of the different components, the order of mixing, the reaction conditions, e.g. temperature and pressure and the choice of organic template.

Methods of improving oxygenate conversion provide savings and economic advantages. One aspect for improving the conversion of oxygenates to olefins is the crystal structure and size of the catalyst. The production of catalysts is sufficiently complex and costly such that a production run of catalysts having a significant flaw in the crystal structure or size can be costly in terms of money and time lost. It would be advantageous to develop methods to test catalysts for quality. The testing can be used to improve operating conditions for production and can save time and expense of lost materials.

### SUMMARY OF THE INVENTION

The invention provides for a catalyst for use in methanol to olefin conversion. The catalyst comprises a silico-aluminophosphate molecular sieve having a SAPO-34 structure, and characterized by an x-ray diffraction pattern having peaks at about 30.7° 2θ and 31.0° 2θ and wherein the ratio of the peak heights at 30.7° 2θ and 31.0° 2θ is greater than about 0.75.

Another aspect of the invention is a process using the x-ray diffraction pattern of the molecular sieve for quality control in the production of the molecular sieve. The x-ray diffraction pattern is determined, the peak heights are found at 30.7° 2θ and 31.0° 2θ, a ratio of the peak heights is computed, and rejecting molecular sieves having a peak height ratio below about 0.75.

Additional objects, embodiments and details of this invention can be obtained from the following detailed description of the invention.

### BRIEF DESCRIPTION OF THE DRAWINGS

FIG. 1 is a schematic showing the layers of tilted double six rings;

FIG. 2 is a comparison of x-ray diffraction patterns for samples of SAPO-34 under different preparation conditions;

FIG. 3 is simulations of x-ray diffraction patterns for different levels of AEI structure type faulting; and

FIG. 4 is comparison of observed XRD patterns for a commercial sample with simulations having different levels of faulting.

### DETAILED DESCRIPTION OF THE INVENTION

Improvements in the conversion of oxygenates to olefins can come from improvements in the catalysts used in the conversion process. One area of improvement is the improvement in the uniformity of the structure for a preferred catalyst. SAPO-34 is one such catalyst used in the methanol to olefin (MTO) conversion process, and improvements in the structure can yield large returns in the olefin yields.

The use of aluminosilicate and silicoaluminophosphate molecular sieves for different processes are dependent on the structures and compositions of the molecular sieves. The structures of the molecular sieves are analyzed by x-ray diffraction (XRD) which generate x-ray diffraction patterns that correspond to known structures. It was discovered that the selectivity for ethylene and propylene in the methanol to olefin process is related to the physical properties of a SAPO-34 material which can be assayed by XRD. Currently, the methanol to olefin process is often performed using SAPO-34 as a major active component of the catalyst. The morphology of and method of producing SAPO-34 is taught in U.S. Pat. No. 6,207,872 B1, issued on Mar. 27, 2001, and is incorporated by reference in its entirety. The morphology of SAPO-34 is important for the use in achieving high yields of ethylene and propylene, or high olefin selectivity.

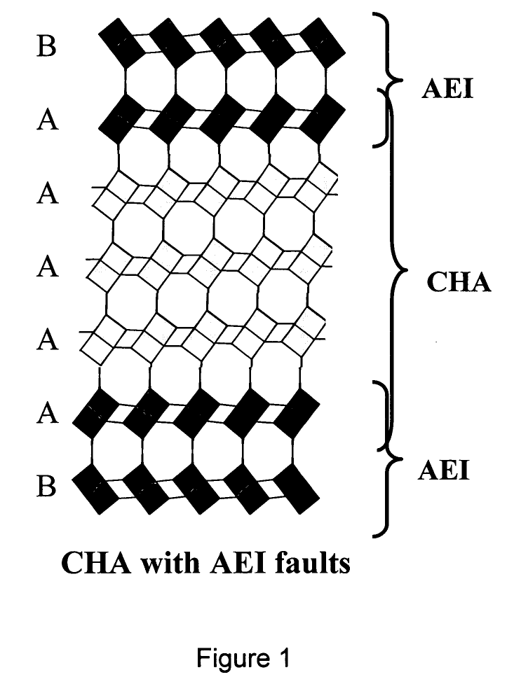

SAPO-34 is a silicoaluminophosphate molecular sieve with a framework structure layer of tilted double six rings (D6R). The D6R layers are periodic building units that make up the molecular sieve, and each layer has an orientation. The structure is a stacking of sheets along the <100> direction of the crystal structure, with the sheets containing slanted double six rings. When the layers are stacked, they can be oriented in the same direction, or in opposite directions where the orientation of the slanted sheets is reversed. When the layers are oriented in the same direction the layers have an AAAA stacking arrangement, and when they are oriented in the reverse direction the layers have an ABAB stacking arrangement. With the AAAA stacking arrangement the molecular sieve has a CHA structure type, and with the ABAB stacking arrangement the molecular sieve has an AEI structure type. In the process of making SAPO-34, the molecular sieve usually has a mixture of structure types within the crystals, and therefore the crystals contain regions of CHA type structure and regions of AEI type structure. A schematic showing the layers of tilted D6Rs demonstrating the CHA structure and the AEI structure is shown in FIG. 1.

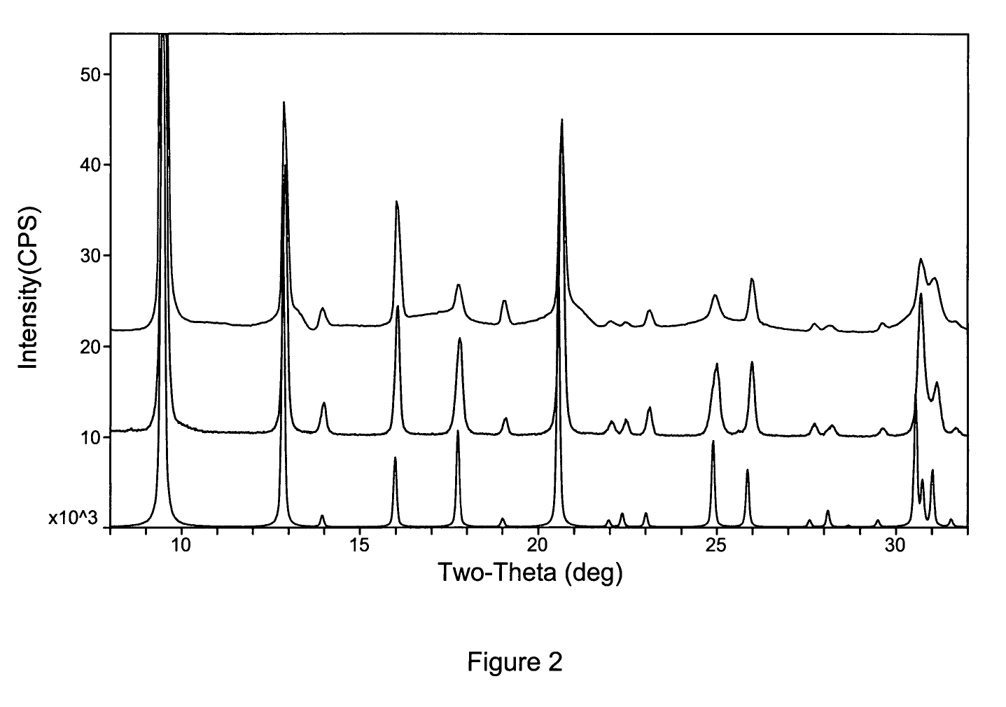

Many preparations of SAPO-34 show differing diffraction patterns, and there are often features that are dissimilar to that expected for a pure CHA structure type. For example, FIG. 2 shows x-ray diffraction patterns for a commercial sample A (top), a sample with the CHA structure type simulated from the single crystal structure (bottom), and a sample with fairly pure CHA structure type (middle). Explanations for the differences are that the commercial sample contained impurities, or disordered regions, also known as faults. The faulted structures occur when there are mixed stacking sequences of the D6R layers.

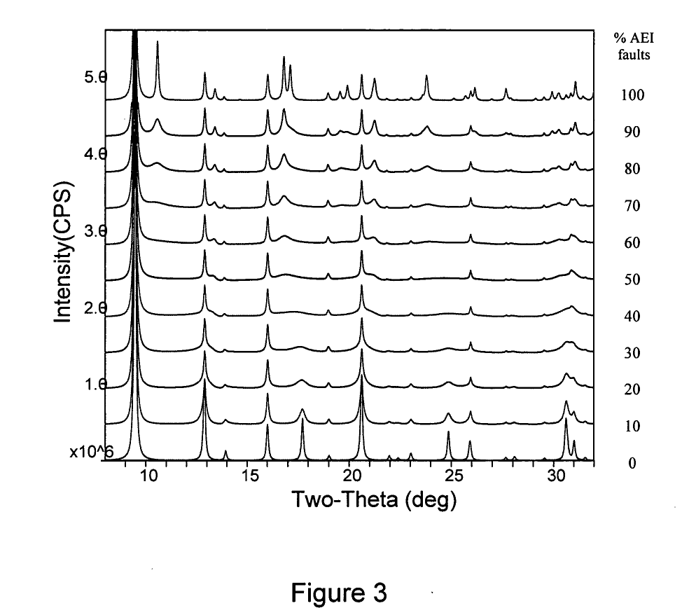

Studying the diffraction patterns for faulted materials requires consideration that the stacking sequences can have different probabilities for occurrence in a structure. The diffraction patterns were studied using software for simulations of diffraction patterns. The most common software is DIFFaX, a computer software program for calculating diffraction intensities that contain planar defects such as stacking faults. For SAPO-34 materials, crystals having a pure CHA structure type corresponds to a 0% faulting, and crystals having a pure AEI structure corresponds to 100% faulting. DIFFAX simulations showing the expected XRD patterns for CHA structure types having 0 to 100% AEI structure type faulting are shown in FIG. 3. As the level of faulting increases, many of the diffraction peaks remain relatively unchanged, while other peaks broaden, shift, and then sharpen. In addition, some peaks disappear, while others appear, showing that the changes in the patterns are complex.

Comparison of XRD patterns from commercial SAPO-34 materials with the simulated patterns can provide estimates for the degree of faulting in the commercial materials. However, it has been found that when actually comparing the results of simulations with that pattern for real materials, the simulations did not fit very well.

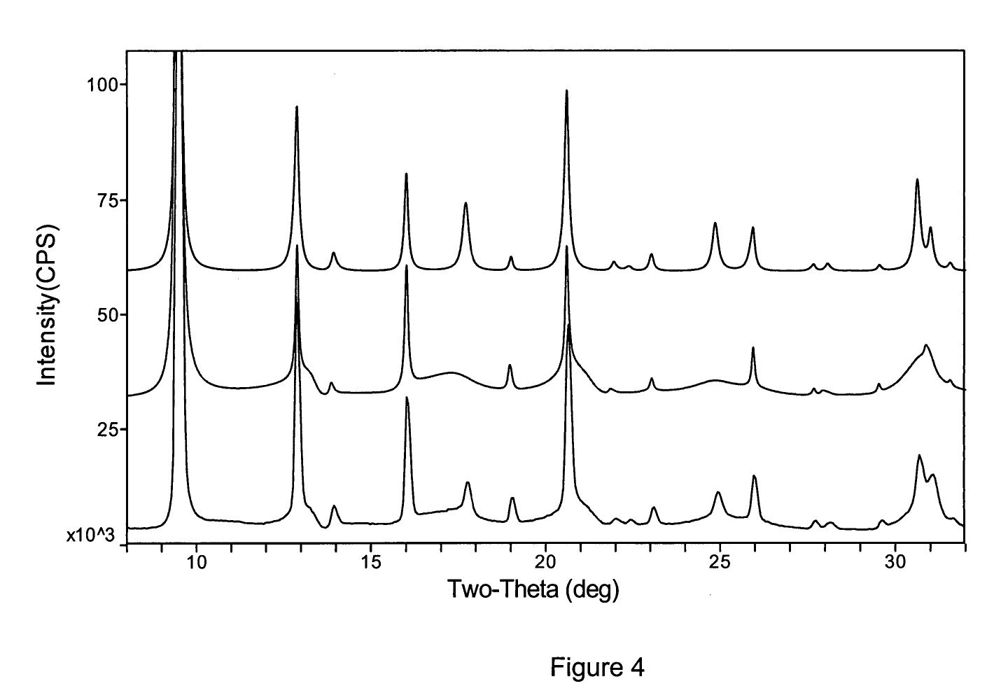

Instead, a more complex combination of simulated patterns is needed to obtain a reasonable match with an observed pattern for a real material. The complex combination often required using combinations of SAPO-34 materials with known levels of faulting, and a more significant analysis of the XRD patterns. It was learned that no single simulation fits real samples well, and that to obtain a reasonable fit, at least two simulations with different levels of faulting is required. As shown in FIG. 4, the commercial sample A (bottom) is compared with a simulation for a CHA structure with 40% AEI faults (middle) and a simulation for a CHA structure with 5% AEI faults. It can be seen that one simulation, the 40% simulation, is needed to fit one part of the commercial sample's XRD, while the other simulation, the 5% simulation, is needed to fit another part of the commercial sample's XRD. This presents the problem of needing to know which levels of faulting to use in the simulations in order to produce results for use in comparison with commercial samples. It is also unlikely that a SAPO-34 has faulting uniformly distributed throughout the crystals, but will have regions of low faulting and regions of high faulting, thereby making comparisons with simulations even more complex and difficult.

The problem is identifying and using a SAPO-34 material for use in MTO processes. A simple search of SAPO materials does not yield a straight forward technique, and use of DIFFAX to get an estimate of faulting is complex. It was initially believed that the determination of percent AEI faulting was too complex for easy implementation for use as a quality control procedure.

Nevertheless, it has been discovered that some SAPO-34 samples having a high fraction of CHA structured regions exhibits XRD patterns produced peaks at about 30.7° 2θ and 31.0° 2θ. Samples without these peaks do not always provide a good catalyst for use in the conversion of oxygenates to olefins, or samples with these peaks and a low peak height ratio have poor selectivity for the production of olefins. But, when the ratio of the peak heights was greater than about 0.75, for a molecular sieve having a SAPO-34 structure, the selectivity for conversion of methanol to low molecular weight olefins was greater than about 80%. It was found that the greater the ratio, the greater the selectivity for SAPO-34 samples exhibiting the peaks. It is preferred that the ratio of peak heights is greater than 0.9, it is more preferred that the ratio of peak heights is greater than 1.1, and it is most preferred that the ratio of peak heights is greater than 1.3.

Even with the differences, there are a number of similarities. The preparation of SAPO-34 is known in the art, as exemplified in U.S. Pat. No. 4,440,871, issued to UOP LLC on Apr. 3, 1984, and is incorporated by reference in its entirety. In general, SAPO-34 as referred to herein is a silicoaluminophosphate material. It has a three-dimensional microporous crystal framework structure of PO₂⁺, AlO₂⁻, and SiO₂ tetrahedral units, and whose essential empirical composition on an anhydrous basis is:
(SiₓAl_{y}P_{z})O₂

where “x”, “y” and “z” represent the mole fractions of silicon, aluminum and phosphorus, respectively, and where x+y+z=1. The silicoaluminophosphate is also characterized by an x-ray powder diffraction pattern having at least six peaks as set forth in Table 1.

TABLE 1

| | | Relative |
|---|---|---|
| 2θ | d-spacing | Intensity |
| 9.45-9.65 | 9.36-9.17 | s-vs |
| 16.0-16.2 | 5.54-5.47 | w-m |
| 17.85-18.15 | 4.97-4.89 | w-s |
| 20.55-20.9 | 4.32-4.25 | m-vs |
| 24.95-25.4 | 3.57-3.51 | w-s |
| 30.5-30.7 | 2.931-2.912 | w-s |

As is understood by those skilled in the art the determination of the parameter 2θ is subject to both human and mechanical error, which in combination can impose an uncertainty of about ±0.4 on each reported 2θ value. This uncertainty is also manifest in the values of the d-spacings, which are calculated from the 2θ values. The relative intensities of the d-spacings are indicated by notations vs, s, m, w and vw which represent very strong, strong, medium, weak and very weak respectively.

A molecular sieve of this structure has a composition found in the ternary diagram for silicon (Si), phosphorus (P), and aluminum (Al) where the amount of silicon has a mole fraction, x, from about 0.01 to about 0.98; the amount of aluminum has a mole fraction, y, from about 0.01 to about 0.6; and the amount of phosphorus has a mole fraction, z, from about 0.01 to about 0.52.

While the composition can encompass a larger domain, it is preferred that the mole fractions of silicon, aluminum and phosphorus fall into a smaller domain. A preferred range for the mole fraction x, of silicon is from about 0.02 to about 0.25; the mole fraction y, of aluminum is from about 0.37 to about 0.6; and the mole fraction z, of phosphorus is from about 0.27 to about 0.49.

The testing of samples of SAPO-34 molecular sieve can be performed using XRD analysis of the samples. Rather than doing a full analysis through the use of DIFFaX, an analysis of the peak heights at about 30.7° 2θ and 31.0° 2θ can be performed. The peak heights can be measured, a ratio computed, and a determination made of whether the sample meets an acceptable preselected value. A minimum preselected value is 0.75 for the peak height ratio, with a preferred value of 0.9, a more preferred value of 1.1, and a most preferred value of 1.3. When the samples have peak height ratios below the preselected value, the molecular sieve is rejected.

For samples meeting or exceeding the preselected value of peak height ratio, a quick check can be made to ensure that the XRD of the sample exhibits peaks in the ranges listed in Table 1 to ensure that the sample meets the criteria of a SAPO-34.

Information from the XRD of samples can be used for feedback in the process of making a SAPO-34, wherein changes in processing temperature, relative amounts of silicon, aluminum and phosphorus, as well as relative amounts of organic templates can be made to improve the quality of the SAPO-34.

### EXAMPLE

The preferred catalyst is a SAPO-34 with the greatest selectivity for the production of ethylene and propylene. The selectivity was compared with the peak ratios computed for each SAPO-34 sample.

TABLE 2

| Sample | Selectivity, % | Peak Ratio |
|---|---|---|
| 1 | 84.9 | 1.41 |
| 2 | 83.6 | 1.29 |
| 3 | 83.1 | 1.14 |
| 4 | 82.9 | 1.10 |
| 5 | 82.2 | 1.06 |
| 6 | 80.9 | 0.92 |
| 7 | 80.0 | 0.76 |
| 8 | 74.4 | 0.32 |

From Table 2, for a desired selectivity value of greater than 82%, catalysts exhibit a peak ratio greater than about 1.06.

While the invention has been described with what are presently considered the preferred embodiments, it is to be understood that the invention is not limited to the disclosed embodiments, but it is intended to cover various modifications and equivalent arrangements included within the scope of the appended claims.

What is claimed is:

1. A silico-aluminophosphate molecular sieve having a SAPO-34 structure characterized by a ratio of peak heights, from the x-ray diffraction pattern, for the peaks at about 30.7° 2θ and 31.0° 2θ of the silico-aluminophosphate, wherein the ratio is greater than about 0.75.

2. The molecular sieve of claim 1 wherein the ratio is greater than 0.9.

3. The molecular sieve of claim 1 wherein the ratio is greater than 1.1.

4. The molecular sieve of claim 1 wherein the ratio is greater than 1.3.

5. The molecular sieve of claim 1 wherein the molecular sieve is further characterized as having an x-ray diffraction pattern having at least the d-spacings and relative intensities set forth in Table 1,
TABLE 1

| | | Relative |
|---|---|---|
| 2θ | d-spacing | Intensity |
| 9.45-9.65 | 9.36-9.17 | s-vs |
| 16.0-16.2 | 5.54-5.47 | w-m |
| 17.85-18.15 | 4.97-4.89 | w-s |
| 20.55-20.9 | 4.32-4.25 | m-vs |
| 24.95-25.4 | 3.57-3.51 | w-s |
| 30.5-30.7 | 2.931-2.912 | w-s |

6. A molecular sieve comprising a silico-aluminophosphate having a framework composition on an anhydrous and calcined basis expressed by an empirical formula of:
(SiₓAl_{y}P_{z})O₂
wherein “x” is the mole fraction of Si and has a value from 0.01 to about 0.98, “y” is the mole fraction of Al and has a value from about 0.01 to about 0.6, “z” is the mole fraction of P and has a value from about 0.01 to about 0.52, and x+y+z=1, and wherein the molecular sieve is a product comprising SAPOs having an AEI structure and CHA structure, and further characterized by peaks in its x-ray diffraction pattern at about 30.7° 2θ and 31.0° 2θ, wherein the ratio of the peak heights is greater than about 0.75.

7. The molecular sieve of claim 6 wherein the mole fraction “x” is from about 0.02 to about 0.25, the mole fraction “y” is from about 0.37 to about 0.6, and the mole fraction “z” is from about 0.27 to about 0.49.

8. A process for identifying high selectivity silico-aluminophosphate molecular sieves for use in converting an oxygenate to olefin comprising:
determining the x-ray diffraction pattern of a molecular sieve;
determining the peak heights for the peaks found at about 30.7° 2θ and about 31.0° 2θ;
computing the peak ratio of the 30.7°:31° peaks; and
rejecting molecular sieves having a peak height ratio below a preselected value.

9. The process of claim 8 wherein the preselected value of the peak height ratio is greater than 0.75.

10. The process of claim 8 wherein the peak height ratio is greater than 0.9.

11. The process of claim 8 wherein the peak height ratio is greater than 1.1.

12. The process of claim 8 wherein the peak height ratio is greater than 1.3.

13. The process of claim 8 wherein the molecular sieve is a SAPO-34.
